(19) United States
(12) Patent Application Publication
(10) Pub. No.: US 2026/0202587 A1
(43) Pub. Date: Jul. 16, 2026

(54) WAVEGUIDE STRUCTURE AND NEAR-EYE DISPLAY DEVICE

(71) Applicants: Beijing Zitiao Network Technology Co., Ltd., Beijing (CN); BYTEDANCE TECHNOLOGY LTD., Grand Cayman (KY)

(72) Inventors: Wen XIONG, Beijing (CN); Wei TAN, Beijing (CN); Peng ZHANG, Los Angeles, CA (US)

(21) Appl. No.: 19/369,933

(22) Filed: Oct. 27, 2025

(30) Foreign Application Priority Data
Jan. 14, 2025 (CN) 202510058876.X

(51) Int. Cl. G02B 1/14; G02B 1/11; G02B 6/34; G02B 27/01

(52) U.S. Cl. CPC G02B 1/14; G02B 1/11; G02B 6/34; G02B 27/0172

(57) ABSTRACT

A waveguide structure and a near-eye display device are provided. The waveguide structure includes a waveguide substrate, a grating structure, a covering layer, and a cover plate layer. The waveguide substrate includes a first surface and a second surface that are provided opposite to each other. The grating structure is on at least one surface of the waveguide substrate. The covering layer covers the grating structure and the waveguide substrate, and the covering layer has a refractive index lower than that of the grating structure. The cover plate layer is at least located at one side of the covering layer away from the grating structure and is attached to the covering layer. The covering layer includes a first covering layer that covers the grating structure, and the first covering layer has a refractive index greater than 1.4.

The present application claims priority of Chinese Patent Application No. 202510058876X, filed on January 14, 2025, the disclosure of which is incorporated herein by reference in its entirety as part of the present application.

### TECHNICAL FIELD

Embodiments of the present disclosure relate to a waveguide structure and a near-eye display device.

### BACKGROUND

At present, augmented reality (AR) glasses have attracted extensive attention because they can overlay virtual objects in real time in real-world environments. An optical waveguide provided in the AR glasses plays an important role. The optical waveguide works by coupling the light emitted by an optical machine into the optical waveguide through a grating, propagating the light in the optical waveguide in total internal reflection until position of the grating, and then coupling the light at the grating position into a human eye position. The optical waveguide has a great impact on the optical performance of AR glasses, if the optical waveguide and the grating are damaged, it will greatly affect the optical display effect of AR glasses, so it is necessary to protect the optical waveguide in AR glasses.

### SUMMARY

The present disclosure relates to a waveguide structure and a near-eye display device.

The present disclosure relates to a waveguide structure, which includes a waveguide substrate, a grating structure, a covering layer, and a cover plate layer. The waveguide substrate includes a first surface and a second surface opposite to each other; the grating structure is located on at least one surface of the waveguide substrate; a covering layer covers the grating structure and the waveguide substrate, a refractive index of the covering layer is smaller than that of the grating structure; the cover plate layer is at least located at one side of the covering layer away from the grating structure and is attached to the covering layer. The covering layer includes a first covering layer that covers the grating structure, and the first covering layer has a refractive index greater than 1.4.

For example, according to an embodiment of the present disclosure, the covering layer further includes a second covering layer, the cover plate layer is attached to the second covering layer, and a refractive index of the second covering layer is lower than the refractive index of the first covering layer.

For example, according to an embodiment of the present disclosure, the first covering layer and the second covering layer are stacked, and the second covering layer is located between the first covering layer and the cover plate layer.

For example, according to an embodiment of the present disclosure, a surface of the first covering layer away from the waveguide substrate is a flat surface, and the first covering layer has a thickness of 1 μm to 100 μm.

For example, according to an embodiment of the present disclosure, in a direction perpendicular to the cover plate layer, a part of the second covering layer does not overlap with the first covering layer.

For example, according to an embodiment of the present disclosure, the first covering layer has a thickness not greater than 0.1 mm.

For example, according to an embodiment of the present disclosure, the first covering layer includes a covering portion that overlaps the grating structure in a direction perpendicular to the cover plate layer, and a distance between the covering portion and the cover plate layer is lower than a distance between at least part of the first covering layer other than the covering portion and the cover plate layer.

For example, according to an embodiment of the present disclosure, the covering portion has a thickness not greater than 1 μm.

For example, according to an embodiment of the present disclosure, in a direction perpendicular to the cover plate layer, the first covering layer does not overlap with the second covering layer.

For example, according to an embodiment of the present disclosure, an air gap is provided between the first covering layer and the cover plate layer.

For example, according to an embodiment of the present disclosure, the refractive index of the second covering layer is lower than 1.3.

For example, according to an embodiment of the present disclosure, the cover plate layer has a thickness not greater than 0.3 mm.

For example, according to an embodiment of the present disclosure, a distance between surfaces of the waveguide substrate and the cover plate layer that are close to each other is not greater than 0.1 mm.

For example, according to an embodiment of the present disclosure, the waveguide substrate has a refractive index of 1.7 to 2.8, and the grating structure has a refractive index of 1.7 to 2.8.

For example, according to an embodiment of the present disclosure, the grating structure is located on one of the first surface and the second surface of the waveguide substrate, the cover plate layer includes a first cover plate layer and a second cover plate layer located on both sides of the waveguide substrate, the first cover plate layer covers the grating structure, the covering layer further includes a third covering layer located between the second cover plate layer and the waveguide substrate, the third covering layer is attached to the second cover plate layer, and the third covering layer has a refractive index lower than that of the first covering layer, and a distance between surfaces of the first cover plate layer and the waveguide substrate that are close to each other is greater than a distance between surfaces of the second cover plate layer and the waveguide substrate that are close to each other.

For example, according to an embodiment of the present disclosure, a material of the third covering layer is the same as that of the second covering layer.

For example, according to an embodiment of the present disclosure, the covering layer further includes an anti-reflective film, and the anti-reflective film includes a plurality of film layers which are arranged in a stacked manner; the anti-reflective film is located between the first covering layer and the second covering layer, or the anti-reflective film is located at least on one side of the first covering layer away from the waveguide substrate.

For example, according to an embodiment of the present disclosure, a surface of at least part of the cover plate layer has at least one selected from the group consisting of a curved morphology and a plurality of microstructures.

Another embodiment of the present disclosure provides a near-eye display device, which includes any waveguide structure as mentioned above.

### BRIEF DESCRIPTION OF DRAWINGS

In order to clearly illustrate the technical solutions of the embodiments of the present disclosure, the drawings of the embodiments will be briefly described in the following; it is obvious that the described drawings are only related to some embodiments of the present disclosure and thus are not limitative to the present disclosure.

FIG. 1 is a cross-sectional structural schematic of a waveguide structure.

FIG. 2 is a schematic diagram of a waveguide structure provided in an example according to an embodiment of the present disclosure.

FIG. 3 to FIG. 5 are schematic diagrams of a waveguide structure provided in various examples according to the embodiment of the present disclosure.

FIG. 6A to FIG. 6F are schematic diagrams of waveguide structures provided in various examples according to the embodiment of the present disclosure.

FIG. 7 is a partial structural diagram of a near-eye display device provided in another embodiment of the present disclosure.

### DETAILED DESCRIPTION

In order to make objects, technical solutions and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments of the present disclosure, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects.

When a quantity of a component is not specifically specified in the following text of the embodiments of the present disclosure, it means that the quantity of such component may be one or more, or may be understood as at least one. The expression “at least one” refers to one or more, and “more” refers to at least two.

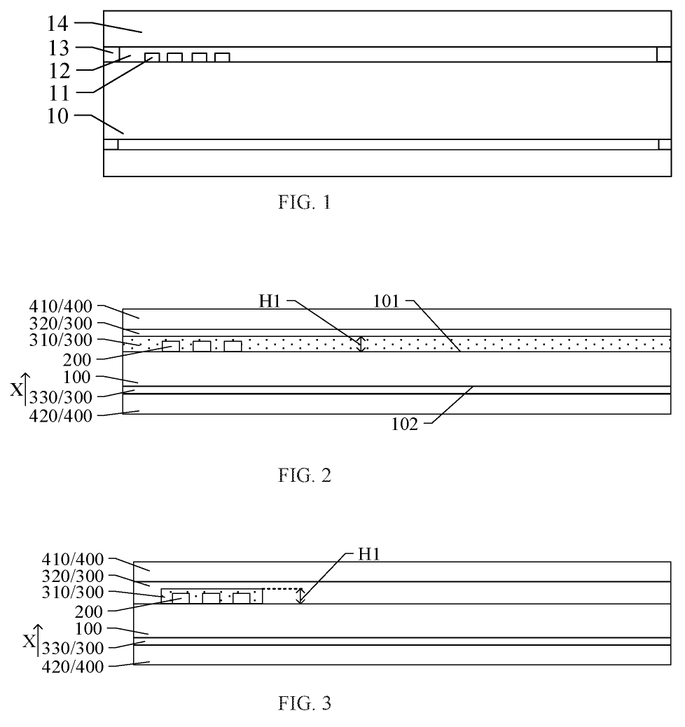

FIG. 1 is a cross-sectional structural schematic of a waveguide structure. As shown in FIG. 1, the waveguide structure includes a waveguide substrate 10, a grating 11, and a cover plate 14, where the grating 11 is provided on the surface of the waveguide substrate 10, and the cover plate 14 is located on both sides of the waveguide substrate 10 to protect the waveguide substrate 10. An air gap 12 is provided between the cover plate 14 and the waveguide substrate 10 to ensure that the light in the waveguide substrate 10 is propagated in total internal reflection. An edge of the cover plate 14 is frame bonded to the waveguide substrate 10 through a frame adhesive 13. The foregoing distance between the waveguide substrate 10 and the cover plate 14 may be 0 to several tens of microns.

In the research, the inventor of the present application found out that in order to protect the waveguide substrate 10 and the grating 11, the foregoing cover plate 14 is typically made of tempered glass with a thickness not too low. The thickness typically needs to be greater than 0.3 mm, thereby increasing the thickness and weight of the waveguide structure.

The present disclosure provides a waveguide structure and a near-eye display device. The waveguide structure includes a waveguide substrate, a grating structure, a covering layer, and a cover plate layer. The waveguide substrate includes a first surface and a second surface that are provided opposite to each other. The grating structure is on at least one surface of the waveguide substrate. The covering layer covers the grating structure and the waveguide substrate, and the covering layer has a refractive index lower than that of the grating structure. The cover plate layer is at least located at one side of the covering layer away from the grating structure and is attached to the covering layer. The covering layer includes a first covering layer that covers the grating structure, and the first covering layer has a refractive index greater than 1.4.

By providing a covering layer between the waveguide substrate and the cover plate layer, the cover plate layer is attached to the covering layer, and by providing the first covering layer in the covering layer with the refractive index greater than 1.4 and lower than the refractive index of the grating structure, the thickness of the cover plate layer may be lowered and the uniformity of the overall display effect may be improved.

The waveguide structure and the near-eye display device provided in the embodiments of the present disclosure are described below with reference to the accompanying drawings.

FIG. 2 is a schematic diagram of a waveguide structure provided in an example according to an embodiment of the present disclosure.

As shown in FIG. 2 the waveguide structure includes a waveguide substrate 100, a grating structure 200, a covering layer 300, and a cover plate layer 400. The waveguide substrate 100 includes a first surface 101 and a second surface 102 that are provided opposite to each other. The grating structure 200 is located on at least one surface of the waveguide substrate 100. The covering layer 300 covers the grating structure 200 and the waveguide substrate 100, and the covering layer 300 has a refractive index lower than that of the grating structure 200. The cover plate layer 400 is at least located at a side of the covering layer 300 away from the grating structure 200 and is attached to the covering layer 300. The covering layer 300 includes a first covering layer 310 that covers the grating structure 200, and the first covering layer 310 has a refractive index greater than 1.4.

By providing a covering layer between the waveguide substrate and the cover plate layer, the cover plate layer is attached to the covering layer, and by providing the first covering layer in the covering layer with a refractive index greater than 1.4 and lower than the refractive index of the grating structure, the thickness of the cover plate layer may be lowered and the uniformity of the overall display effect may be improved without affecting the protection function of the covering plate, which help reduce the weight of the near-eye display device when the waveguide structure is applied to the near-eye display device, thereby improving the wearing experience.

For example, as shown in FIG. 2, at least part of the covering layer 300 is sandwiched between the covering layer 400 and the waveguide substrate 100. The waveguide substrate 100 is a light-transmitting substrate, and the waveguide substrate 100 is made of a material with a high refractive index. The covering layer 300 has a refractive index lower than the refractive index of the grating structure 200.

In some examples, as shown in FIG. 2, the waveguide substrate 100 has a refractive index of 1.7 to 2.8, and the grating structure 200 has a refractive index of 1.7 to 2.8. For example, the waveguide substrate 100 has a refractive index that is the same as or different from that of the grating structure 200. For example, the waveguide substrate 100 may have a refractive index of 1.8 to 2, or 1.9 to 2.5, or 2.2 to 2.7, or the like. The embodiments of the present disclosure do not enumerate the specific ranges of the refractive index of the waveguide substrate one by one, and the refractive index of the waveguide substrate may be any value in the range of 1.7 to 2.8. For example, the refractive index of the grating structure 200 may be 1.9 to 2.6, or 2 to 2.5, or 2.2 to 2.7, or the like. The embodiments of the present disclosure do not enumerate the specific ranges of the refractive index of the grating structure one by one, and the refractive index of the grating structure may be any value in the range of 1.7 to 2.8.

For example, as shown in FIG. 2, the grating structure 200 includes an in-coupling grating and an out-coupling grating, and the image light emitted from the display screen may be coupled into the waveguide substrate 100 through the in-coupling grating, and is propagated in total internal reflection within the waveguide substrate 100, and then exited to the eyes of the user through the out-coupling grating. FIG. 2 shows an in-coupling grating or an out-coupling grating in the grating structure 200. For example, the grating structure 200 may be a diffractive grating, for example, a transmissive grating, or a reflective grating. For example, the grating structure 200 may include a plurality of slits and the first covering layer 310 may fill the slits. By providing the first covering layer 310 that fills the slits with a refractive index greater than 1.4, materials of the first covering layer 310 may be selected conveniently while maintaining the diffraction efficiency, diffraction uniformity and transmittance of the grating structure 200, which eliminates the process of specially making the first covering layer 310 with low refractive index characteristics, thereby saving the cost.

For example, as shown in FIG. 2, the first covering layer 310 may be made of a light-transmitting material. For example, the first covering layer 310 has a refractive index greater than 1.45. For example, the first covering layer 310 has a refractive index greater than 1.5. For example, the first covering layer 310 has a refractive index not greater than 1.7. For example, the first covering layer 310 may be made of an organic adhesive.

In some examples, as shown in FIG. 2, the cover plate layer 400 has a thickness not greater than 0.3 millimeters. For example, the cover plate layer 400 has a thickness not greater than 0.2 mm. For example, the cover plate layer 400 has a thickness not greater than 0.1 mm. The embodiments of the present disclosure do not hereby enumerate the specific ranges of the thickness of the cover plate layer 400, and the thickness of the cover plate layer 400 may be any value greater than 0 and not greater than 0.3. For example, the cover plate layer 400 may be made of a light-transmitting material, such as a tempered glass, a glass, an ultra-thin glass, a resin, or the like.

Compared to the waveguide structure shown in FIG. 1, the waveguide structure provided by the embodiment of the present disclosure can significantly reduce the thickness of the cover plate layer by disposing the covering layer and replacing the frame bonding between the cover plate layer and the waveguide substrate with the surface bonding between the cover plate layer and the covering layer, where the thickness of the cover plate layer is much lower than the thickness of the cover plate with an air gap as shown in FIG. 1.

For example, as shown in FIG. 2, one side of the covering layer 300 is in contact with or attached to the grating structure 200 and the waveguide substrate 100, and the other side of the covering layer 300 is in contact with or attached to the cover plate layer 400.

In the waveguide structure provided in the present disclosure, replacing the air gap in a conventional waveguide structure (as shown in FIG. 1) with the covering layer helps ensure the function of the waveguide structure to transmit light, and the cover plate layer not only protects the waveguide substrate and the grating structure, but also plays the role of buffering external force, thereby reducing the thickness of the cover plate layer, and the weight of the cover plate layer.

In some examples, as shown in FIG. 2, the covering layer 300 further includes a second covering layer 320, where the cover plate layer 400 is attached to the second covering layer 320, and the refractive index of the second covering layer 320 is lower than that of the first covering layer 310. The cover plate layer 400 is attached to the second covering layer 320 may refer to that the cover plate layer 400 is in direct contact with the second covering layer 320, or that the cover plate layer 400 and the second covering layer 320 are bonded by optical adhesive.

In some examples, as shown in FIG. 2, the first covering layer 310 and the second covering layer 320 are stacked, and the second covering layer 320 is located between the first covering layer 310 and the cover plate layer 400. Providing the second covering layer with a low refractive index between the first covering layer and the cover plate layer not only can replace the original air gap to match the refractive index of the waveguide substrate and provide total reflection propagation for the light incident into the waveguide substrate at a certain angle, thereby improving the overall light efficiency, but also can protect the waveguide substrate, reduce the thickness and weight of the cover plate layer, and also ensure the effective diffraction of the grating structure, which avoids affecting the display quality due to the direct contact of the cover plate layer with the first covering layer. For example, because the refractive index of the first covering layer is relatively high, if the cover plate layer is in direct contact with the first covering layer, the conditions for total internal reflection are not met, which prevents the light that could be originally fully reflected at the interface cannot be fully reflected and enter the cover plate layer, thereby affecting the display quality.

In some examples, as shown in FIG. 2, the second covering layer 320 has a refractive index lower than 1.3. For example, the second covering layer 320 has a refractive index lower than 1.2. For example, the second covering layer 320 has a refractive index lower than 1.1. The embodiments of the present disclosure do not enumerate the specific ranges of the refractive index of the second covering layer 320 one by one, and the refractive index of the second covering layer 320 may be any value greater than 1 and lower than 1.3.

For example, as shown in FIG. 2, the second covering layer 320 includes a light-transmitting material. For example, the second covering layer 320 may be made of an organic adhesive. For example, the material of the organic adhesive typically has a loose and porous structure, which makes it have a lower refractive index.

For example, as shown in FIG. 2, the first covering layer 310 covers the grating structure 200 and the waveguide substrate 100, and the second covering layer 320 covers the first covering layer 310.

In some examples, as shown in FIG. 2, the distance between surfaces of the waveguide substrate 100 and the cover plate layer 400 that are close to each other is not greater than 0.1 mm. For example, in the case where the spacing between the waveguide substrate 100 and the cover plate layer 400 is not greater than 0.1 mm, the thickness of the covering layer 300 is not greater than 0.1 mm.

By setting the distance between the waveguide substrate and the cover plate layer, the covering layer and the cover plate layer may jointly protect the grating structure and the waveguide substrate, providing the overall waveguide structure with a low thickness and weight.

In some examples, as shown in FIG. 2, the surface of the first covering layer 310 away from the waveguide substrate 100 is a flat surface, and the thickness H1 of the first covering layer 310 is 1 μm to 100 μm. For example, the surface of the second covering layer 320 away from the waveguide substrate 100 is a flat surface. By disposing the thickness of the first covering layer, the first covering layer may fill and level the grating structure, so that even when the second covering layer has a lower thickness, a flat supporting surface can also be provided for the cover plate layer.

For example, as shown in FIG. 2, the thickness H1 of the first covering layer 310 may be 10 μm to 50 μm. For example, the thickness H1 of the first covering layer 310 may be 30 μm to 70 μm. For example, the thickness H1 of the first covering layer 310 may be 20 μm to 60 μm. The embodiments of the disclosure do not enumerate the thickness ranges of the first covering layer 310 one by one, and the thickness of the first covering layer 310 may be any value in the range of 1 μm to 100 μm.

The thickness of the first covering layer 310 as mentioned above may refer to the thickness of the part outside the overlapping region of the first covering layer 310 and the grating structure 200, such as the maximum thickness of the first covering layer 310. The thickness difference of a part of the first covering layer 310 in the region where the grating structure 200 is located and a part of the first covering layer 310 in the region without the grating structure 200 is very low and negligible.

For example, as shown in FIG. 2, the first covering layer 310 may be formed by spin coating. For example, the first covering layer 310 is in contact with the grating structure 200. For example, the first covering layer 310 is in contact with the waveguide substrate 100.

In some examples, as shown in FIG. 2, the grating structure 200 is located on one of the first surface 101 and the second surface 102 of the waveguide substrate 100. For example, the grating structure 200 is located on only one surface of the waveguide substrate 100. For example, the waveguide substrate 100 includes the first surface 101 and the second surface 102 that are provided opposite to each other in the X direction, and one surface of the waveguide substrate 100, such as the first surface 101, is provided with the grating structure 200, and the other surface, such as the second surface 102, is not provided with the grating structure 200. However, it is not limited thereto. The first surface and the second surface may be interchanged. For example, the second surface is provided with the grating structure, and the first surface is not provided with the grating structure. For example, the human eye and the display screen may be on the same side of the waveguide substrate 100, and the in-coupling grating and the out-coupling grating included in the grating structure 200 may be on the same side of the waveguide substrate 100. Of course, the embodiments of the present disclosure are not limited thereto, and the in-coupling grating and the out-coupling grating may be located on both sides of the waveguide substrate.

In some examples, as shown in FIG. 2, the cover plate layer 400 includes a first cover plate layer 410 and a second cover plate layer 420 located on both sides of the waveguide substrate 100, where the first cover plate layer 410 covers the grating structure 200. The covering layer 300 further includes a third covering layer 330 located between the second cover plate layer 420 and the waveguide substrate 100, where the third covering layer 330 is attached to the second cover plate layer 420, and the third covering layer 330 has a refractive index lower than that of the first covering layer 310, and the distance between surfaces of the first cover plate layer 410 and the waveguide substrate 100 that are close to each other is greater than the distance between surfaces of the second cover plate layer 420 and the waveguide substrate 100 that are close to each other.

The waveguide structure provided in the present disclosure only provides the grating structure on one side of the waveguide substrate, which helps reduce the thickness of the third covering layer on the side of the waveguide substrate that is not provided with the grating structure, such that the third covering layer and the second cover plate layer jointly protect the waveguide substrate, reduce the thickness of the second cover plate layer, reduce the weight of the second cover plate layer, and improve the light transmittance of the waveguide structure while matching the third covering layer to the waveguide substrate to provide total internal reflection for the light that is propagated in the waveguide substrate.

For example, as shown in FIG. 2, the first cover plate layer 410 and the second cover plate layer 420 may be made of the same material and have the same thickness.

For example, as shown in FIG. 2, the thickness of the third covering layer 330 is lower than that of the first covering layer 310.

In some examples, as shown in FIG. 2, the material of the third covering layer 330 is the same as that of the second covering layer 320. The third covering layer is configured to be made of the same material as that of the second covering layer to avoid affecting the passage of light, for example, the refractive index of the third covering layer is not greater than 1.3.

For example, as shown in FIG. 2, the thickness of the third covering layer 330 may be the same as or different from that of the second covering layer 320.

Of course, the embodiments of the present disclosure are not limited thereto, and the grating structure may be provided on both sides of the waveguide substrate, whereby the first covering layer and the second covering layer are provided on both sides of the waveguide substrate, and the covering layers on both sides of the waveguide substrate may have the same characteristics.

For example, as shown in FIG. 2, the cover plate layer 400 may be a flat structure. For example, the first cover plate layer 410 and the second cover plate layer 420 are both flat plate structures.

FIG. 3 to FIG. 5 are schematic diagrams of a waveguide structure provided in various examples according to the embodiments of the present disclosure. The waveguide structures in the examples shown in FIG. 3 to FIG. 5 differ from the waveguide structure in the example shown in FIG. 2 in that the covering layer 300 has a different shape. For example, the first covering layer 310 has a different shape.

In some examples, as shown in FIG. 3, in a direction perpendicular to the cover plate layer 400, such as in the X direction, a part of the second covering layer 320 does not overlap with the first covering layer 310. For example, the first covering layer 310 only covers the grating structure 200. For example, except the part of the waveguide substrate 100 that is provided with the grating structure 200, the surface of the waveguide substrate 100 is in contact with the second covering layer 320.

Providing the first covering layer only at the position of the grating structure helps improve the display effect, where the second covering layer matches the refractive index of the waveguide substrate so that the light incident into the waveguide substrate at a certain incident angle may be propagated in the waveguide substrate in total reflection, thereby improving the overall uniformity. In addition, the second covering layer and the cover plate layer jointly protect the waveguide substrate, which reduces the thickness of the cover plate layer and the weight of the cover plate layer, thereby improving the light transmittance of the waveguide structure.

In some examples, as shown in FIG. 3, the thickness H1 of the first covering layer 310 is not greater than 0.1 mm. For example, the thickness of the first covering layer 310 is lower than the distance between the waveguide substrate 100 and the cover plate layer 400, such that a spacing is provided between the first covering layer 310 and the cover plate layer 400, where the second covering layer 320 is provided in the spacing.

For example, as shown in FIG. 3, the thickness H1 of the first covering layer 310 is lower than 0.08 mm. For example, the thickness H1 of the first covering layer 310 is lower than 0.05 mm. The embodiments of the present disclosure do not enumerate the thickness ranges of the first covering layer 310 one by one, and the thickness of the first covering layer 310 may be any value greater than 0 and not greater than 0.1 mm.

For example, as shown in FIG. 3, the orthographic projection of the grating structure 200 on the waveguide substrate 100 is entirely within the orthographic projection of the first covering layer 310 on the waveguide substrate 100.

For example, as shown in FIG. 3, the first covering layer 310 may be formed only on the grating structure by inkjet coating.

For example, as shown in FIG. 3, the third covering layer 330 may be made of the same material as that of the second covering layer 320, and the maximum thickness of the second covering layer 320 is greater than the maximum thickness of the third covering layer 330.

For example, as shown in FIG. 3, a surface of the second covering layer 320 away from the waveguide substrate 100 is a flat surface for attaching to the cover plate layer 400.

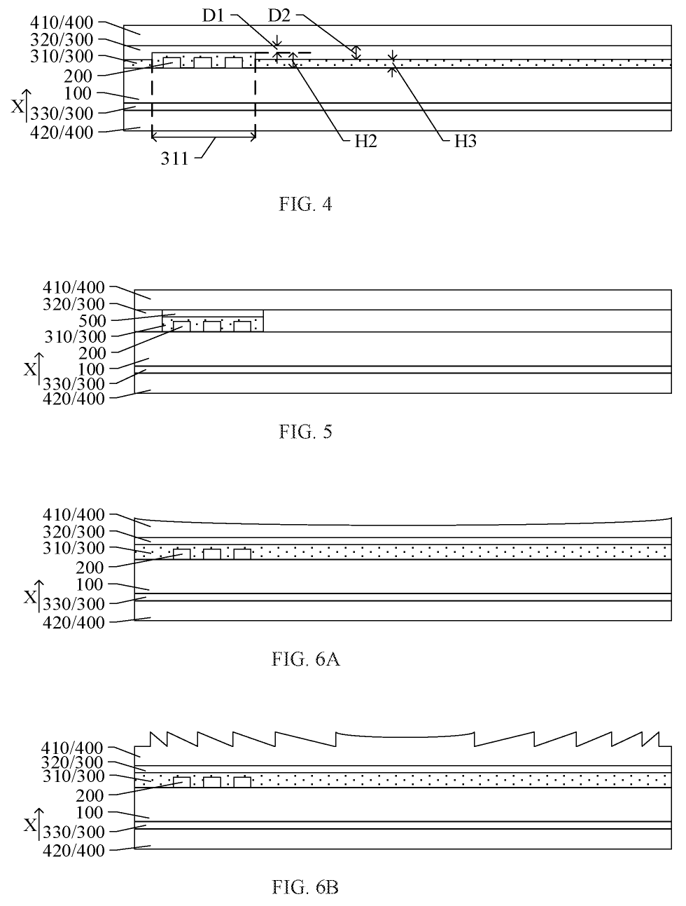

In some examples, as shown in FIG. 4, the first covering layer 310 includes a covering portion 311 that overlaps the grating structure 200 in a direction perpendicular to the cover plate layer 400, and a distance D1 between the covering portion 311 and the cover plate layer 400 is lower than a distance D2 between at least part of the first covering layer 310 other than the covering portion 311 and the cover plate layer 400.

The waveguide structure provided in this example helps improve the display effect, while reducing the thickness of the first covering layer, improving the matching effect between the second covering layer and the waveguide substrate, reducing the thickness of the cover plate layer and the weight of the cover plate layer, and improving the light transmittance of the waveguide structure.

For example, as shown in FIG. 4, the orthographic projection of the grating structure 200 on the waveguide substrate 100 is entirely within the orthographic projection of the covering portion 311 on the waveguide substrate 100.

In some examples, as shown in FIG. 4, a thickness H2 of the covering portion 311 is not greater than 1 μm. For example, the thickness H2 of the covering portion 311 may be greater than a thickness H3 of the part of the first covering layer 310 that does not overlap with the grating structure 200. For example, the thickness of the covering portion 311 is not greater than 0.8 μm. For example, the thickness of the covering portion 311 is not greater than 0.5 μm, or the like. The embodiments of the present disclosure do not enumerate the thickness ranges of the covering portion 311 one by one, and the thickness of the covering portion 311 may be any value greater than 0 and not greater than 1 mm.

For example, as shown in FIG. 4, the first covering layer 310 may be formed by spin coating. For example, the first covering layer 310 is in contact with the grating structure 200. For example, the first covering layer 310 is in contact with the waveguide substrate 100.

For example, as shown in FIG. 4, the third covering layer 330 may be made of the same material as that of the second covering layer 320, and the maximum thickness of the second covering layer 320 is greater than the maximum thickness of the third covering layer 330.

For example, as shown in FIG. 4, a surface of the second covering layer 320 away from the waveguide substrate 100 is a flat surface for attaching to the cover plate layer 400.

In some examples, as shown in FIG. 5, in a direction perpendicular to the cover plate layer 400, the first covering layer 310 does not overlap with the second covering layer 320. For example, the orthographic projection of the first covering layer 310 on the waveguide substrate 100 does not overlap with the orthographic projection of the second covering layer 320 on the waveguide substrate 100.

In the waveguide structure provided in this example, by configuring the first covering layer as not overlapping with the second covering layer, it helps improve the display effect, where the second covering layer matches the refractive index of the waveguide substrate so that the light incident into the waveguide substrate at a certain incident angle may be propagated in the waveguide substrate in total internal reflection, thereby improving the overall optical efficiency. In addition, the second covering layer and the cover plate layer jointly protect the waveguide substrate, which reduces the thickness of the cover plate layer and the weight of the cover plate layer, thereby improving the light transmittance of the waveguide structure.

In some examples, as shown in FIG. 5, an air gap 500 is provided between the first covering layer 310 and the cover plate layer 400. Providing the air gap 500 between the first covering layer 310 and the cover plate layer 400 may reduce the thickness of the cover plate layer 400, while reducing the weight of the waveguide structure, thereby improving the light transmittance of the waveguide structure.

For example, as shown in FIG. 5, the second covering layer 320 surrounds the first covering layer 310.

For example, as shown in FIG. 5, the thickness of the first covering layer 310 is not greater than 0.1 mm. For example, the thickness of the first covering layer 310 is lower than 0.08 mm. For example, the thickness of the first covering layer 310 is lower than 0.05 mm. The embodiments of the present disclosure do not enumerate the thickness ranges of the first covering layer 310 one by one, and the thickness of the first covering layer 310 may be any value greater than 0 and not greater than 0.1 mm.

For example, as shown in FIG. 5, the orthographic projection of the grating structure 200 on the waveguide substrate 100 is entirely within the orthographic projection of the first covering layer 310 on the waveguide substrate 100.

For example, as shown in FIG. 5, the first covering layer 310 may be formed only on the grating structure by inkjet coating.

For example, as shown in FIG. 5, the third covering layer 330 may be made of the same material as that of the second covering layer 320, and the maximum thickness of the second covering layer 320 is greater than the maximum thickness of the third covering layer 330.

FIG. 3 to FIG. 5 schematically show that the grating structure 200 is located only on one side of the waveguide substrate 100. Of course, the embodiments of the present disclosure are not limited thereto, and the grating structure may be provided on both sides of the waveguide substrate, whereby the first covering layer 310 and the second covering layer 320 are provided on both sides of the waveguide substrate 100, and the covering layers 300 on both sides of the waveguide substrate 100 may have the same characteristics.

The waveguide substrate 100, the grating structure 200, and the cover plate layer 400 in the waveguide structure in the examples shown in FIG. 3 to FIG. 5 may have the same characteristics as the waveguide substrate 100, the grating structure 200, and the cover plate layer 400 in the waveguide structure shown in FIG. 2, which are not described again here.

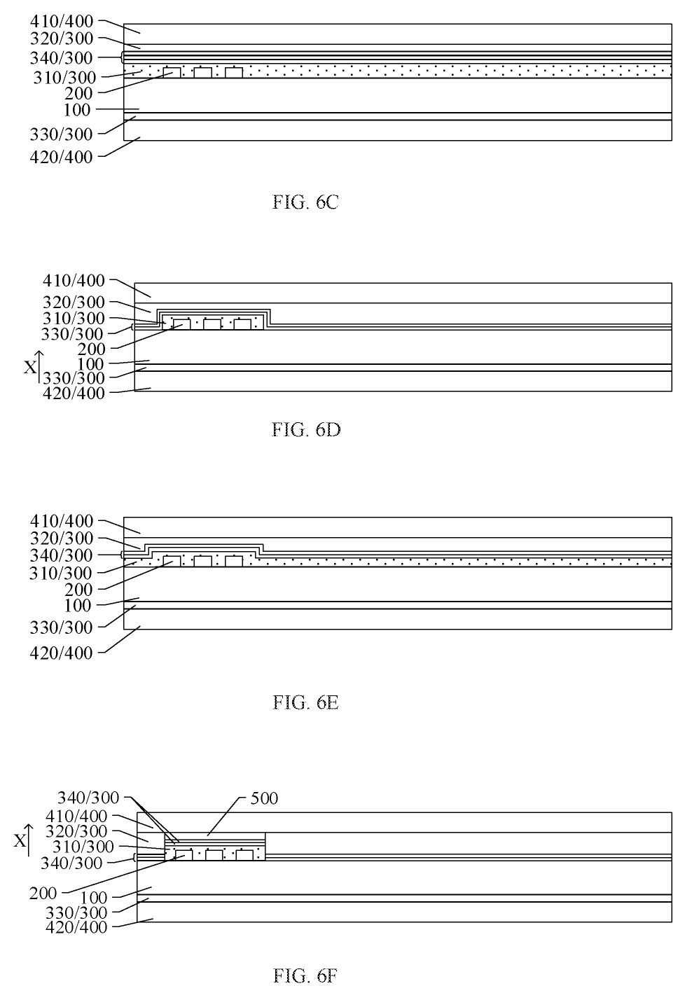

FIG. 6A to FIG. 6F are schematic diagrams of waveguide structures provided in various examples according to the embodiment of the present disclosure.

FIG. 6A is a schematic diagram of a waveguide structure provided in another example according to the embodiment of the present disclosure. The waveguide structure shown in FIG. 6A differs from the waveguide structure shown in FIG. 2 in that the cover plate layer 400 has a different shape.

In some examples, as shown in FIG. 6A, at least part of the cover plate layer 400 has a curved surface. Configuring the curved surface in at least part of the cover layer may increase the application scenarios of waveguide structures, such as in nearsighted lenses, farsighted lenses, or the like.

For example, as shown in FIG. 6A, a surface of the cover plate layer 400 away from the waveguide substrate 100 is bent to the side close to the waveguide substrate 100. For example, the surface of the first cover layer 410 away from the waveguide substrate 100 is bent to the side close to the waveguide substrate 100. For example, the thickness of the central region of the cover plate layer 400 is lower than the thickness of the edge region of the cover plate layer 400.

Of course, the embodiments of the present disclosure are not limited to that the first cover layer has a curved surface. For example, at least one of the first cover plate layer and the second cover plate layer has a curved surface. For example, the outside surface of the cover layer may be bent closer to the waveguide substrate to form a concave lens; or it may be bent away from the waveguide substrate to form a convex lens, in which case the waveguide structure may be a structure in a farsighted lens. For example, at least one of the cover plate layers on both sides may be a plano-concave lens, or plano-convex lens, and the shape of the cover plate layer is configured depending on the application scenario.

The waveguide substrate 100, the grating structure 200, and the covering layer 300 in the waveguide structure in the examples shown in FIG. 6A may have the same characteristics as the waveguide substrate 100, the grating structure 200, and the covering layer 300 in the waveguide structure shown in FIG. 2, which are not described again here.

The covering layer 300 shown in FIG. 6A is not limited to the covering layer 300 in the example shown in FIG. 2, but may also be the covering layer 300 in any of the examples shown in FIG. 3 to FIG. 5.

The waveguide structure shown in FIG. 6B differs from the waveguide structure shown in FIG. 6A in that the cover plate layer 400 has a different shape.

In some examples, as shown in FIG. 6B, at least part of the cover plate layer 400 has a plurality of microstructures. It helps provide refractive correction by configuring the surface of at least part of the cover plate layer to have a plurality of microstructures.

For example, as shown in FIG. 6B, the surface where the plurality of microstructures are located may be formed as a Fresnel surface. For example, a Fresnel surface may be the surface of the cover plate layer away from the waveguide substrate, or may be the surface of the cover plate layer that faces the waveguide substrate.

The waveguide structure shown in FIG. 6C is different from the waveguide structure shown in FIG. 2 in that the covering layer 300 further includes an anti-reflective film 340, where the anti-reflective film 340 includes a plurality of film layers which are arranged in a stacked manner, and the anti-reflective film 340 is located between the first covering layer 310 and the second covering layer 320.

It helps reduce the reflection of light at the interface between the first covering layer and the second covering layer and improve the transmittance of light by configuring the anti-reflective film with the plurality of film layers arranged in a stacked manner between the first covering layer and the second covering layer that have different refractive indexes.

For example, as shown in FIG. 6C, the thickness of the anti-reflective film 340 is lower than that of the second covering layer. For example, the thickness of the anti-reflective film 340 is lower than that of the first covering layer.

FIG. 6C schematically shows that the anti-reflective film includes three film layers, but is not limited thereto, and may also include more layers, such as five film layers, ten film layers, or the like.

For example, as shown in FIG. 6C, the anti-reflective film 340 is located on the side of the first covering layer 310 away from the waveguide substrate 100.

The waveguide structure shown in FIG. 6D is different from the waveguide structure shown in FIG. 3 in that the covering layer 300 further includes an anti-reflective film 340, where the anti-reflective film 340 includes a plurality of film layers which are arranged in a stacked manner, and the anti-reflective film 340 is located between the first covering layer 310 and the second covering layer 320.

It helps reduce the reflection of light at the interface between the first covering layer and the second covering layer and improve the transmittance of light by configuring the anti-reflective film with the plurality of film layers arranged in a stacked manner between the first covering layer and the second covering layer that have different refractive indexes.

For example, as shown in FIG. 6D, the anti-reflective film 340 is located between the second covering layer 320 and the waveguide substrate 100. For example, a part of the anti-reflective film 340 is located between the first covering layer 310 and the second covering layer 320, and the other part of the anti-reflective film 340 is located between the second covering layer 320 and the waveguide substrate 100.

It helps improve the transmittance of light by providing the anti-reflective film with the plurality of film layers arranged in a stacked manner between the second covering layer and the waveguide substrate that have different refractive indexes.

The embodiments of the present disclosure are not limited thereto, and the anti-reflective film may also be located only between the first covering layer and the second covering layer.

For example, as shown in FIG. 6D, the thickness of the anti-reflective film 340 is lower than that of the second covering layer. For example, the thickness of the anti-reflective film 340 is lower than that of the first covering layer.

FIG. 6D schematically shows that the anti-reflective film includes two film layers, but is not limited thereto, and may also include more layers, such as five film layers, ten film layers, or the like.

The waveguide structure shown in FIG. 6E is different from the waveguide structure shown in FIG. 4 in that the covering layer 300 further includes an anti-reflective film 340, where the anti-reflective film 340 includes a plurality of film layers which are arranged in a stacked manner, and the anti-reflective film 340 is located between the first covering layer 310 and the second covering layer 320.

It helps reduce the reflection of light at the interface between the first covering layer and the second covering layer and improve the transmittance of light by configuring the anti-reflective film with the plurality of film layers arranged in a stacked manner between the first covering layer and the second covering layer with different refractive indexes.

For example, as shown in FIG. 6E, the thickness of the anti-reflective film 340 is lower than that of the second covering layer. For example, the thickness of the anti-reflective film 340 is lower than that of the first covering layer.

FIG. 6E schematically shows that the anti-reflective film includes two film layers, but is not limited thereto, and may also include more layers, such as five film layers, ten film layers, or the like.

The waveguide structure shown in FIG. 6F is different from the waveguide structure shown in FIG. 5 in that the covering layer 300 further includes an anti-reflective film 340, where the anti-reflective film 340 includes a plurality of film layers which are arranged in a stacked manner, and the anti-reflective film 340 is located at least on the side of the first covering layer 310 away from the waveguide substrate 100.

It helps improve the transmittance of light by providing the anti-reflective film with the plurality of film layers arranged in a stacked manner at least on the side of the first covering layer away from the waveguide substrate.

For example, as shown in FIG. 6F, the anti-reflective film 340 may only cover the first covering layer 310, such as in the X direction, and the anti-reflective film 340 may not overlap with the second covering layer 320. For example, the anti-reflective film 340 may include a first portion located on the side of the first covering layer 310 away from the waveguide substrate 100 and a second portion located between the second covering layer 320 and the waveguide substrate 100. For example, an air gap 500 may be provided between the anti-reflective film 340 that covers the first covering layer 310 and the cover plate layer 400, but it is not limited thereto, and the anti-reflective film may also be in contact with the cover plate layer.

For example, as shown in FIG. 6F, the thickness of the anti-reflective film 340 is lower than that of the first covering layer 310.

FIG. 6F schematically shows that the anti-reflective film includes two film layers, but is not limited thereto, and may also include more layers, such as five film layers, ten film layers, or the like.

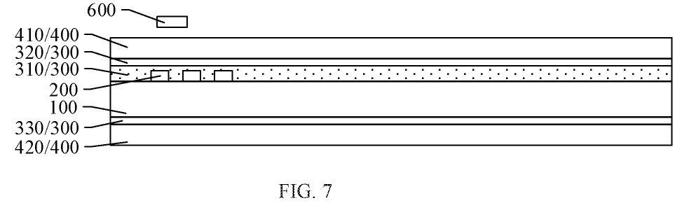

FIG. 7 is a partial structural diagram of a near-eye display device provided in another embodiment of the present disclosure.

As shown in FIG. 7, the near-eye display device includes the waveguide structure in any one of the above examples. FIG. 7 schematically shows the waveguide structure as shown in FIG. 2, but the waveguide structure is not limited thereto, and may also be the waveguide structure in any of the examples shown in FIG. 3 to FIG. 6F.

For example, as shown in FIG. 7, the near-eye display device includes an optical machine 600 located on one side of the waveguide structure. For example, the optical machine 600 is located on the incident light side of the waveguide structure, where the light is coupled into the waveguide substrate 100 through the grating structure 200. For example, the optical machine 600 includes a display screen, an optical lens component, and a positioning structure.

For example, as shown in FIG. 7, the display screen may be any type of display screens, such as a liquid crystal display, an inorganic light-emitting diode display screen, a quantum dot display screen, a projector (such as LCOS micro projector), and the like.

For example, the near-eye display device may be an augmented reality (AR) display device.

For example, the near-eye display device may be a wearable AR helmet, AR glasses, and the like, and the embodiments of the present disclosure are not limited thereto. For example, the near-eye display device includes a lens that includes the waveguide structure described above.

The following statements should be noted:

(1) In the accompanying drawings of the embodiments of the present disclosure, the drawings involve only the structure(s) in connection with the embodiment(s) of the present disclosure, and other structure(s) can be referred to common design(s).

(2) In case of no conflict, features in one embodiment or in different embodiments can be combined.

What have been described above are only specific implementations of the present disclosure, the protection scope of the present disclosure is not limited thereto, and the protection scope of the present disclosure should be based on the protection scope of the claims.

1. A waveguide structure, comprising:
a waveguide substrate, comprising a first surface and a second surface opposite to each other;
a grating structure, located on at least one surface of the waveguide substrate;
a covering layer, covering the grating structure and the waveguide substrate, wherein a refractive index of the covering layer is smaller than that of the grating structure;
a cover plate layer, at least located at one side of the covering layer away from the grating structure and attached to the covering layer;
wherein the covering layer comprises a first covering layer that covers the grating structure, and the first covering layer has a refractive index greater than 1.4.

2. The waveguide structure according to claim 1, wherein the covering layer further comprises a second covering layer, the cover plate layer is attached to the second covering layer, and a refractive index of the second covering layer is lower than the refractive index of the first covering layer.

3. The waveguide structure according to claim 2, wherein the first covering layer and the second covering layer are stacked, and the second covering layer is located between the first covering layer and the cover plate layer.

4. The waveguide structure according to claim 3, wherein a surface of the first covering layer away from the waveguide substrate is a flat surface, and the first covering layer has a thickness of 1 μm to 100 μm.

5. The waveguide structure according to claim 3, wherein, in a direction perpendicular to the cover plate layer, a part of the second covering layer does not overlap with the first covering layer.

6. The waveguide structure according to claim 5, wherein the first covering layer has a thickness not greater than 0.1 mm.

7. The waveguide structure according to claim 3, wherein the first covering layer comprises a covering portion that overlaps the grating structure in a direction perpendicular to the cover plate layer, and a distance between the covering portion and the cover plate layer is lower than a distance between at least part of the first covering layer other than the covering portion and the cover plate layer.

8. The waveguide structure according to claim 7, wherein the covering portion has a thickness not greater than 1 μm.

9. The waveguide structure according to claim 2, wherein, in a direction perpendicular to the cover plate layer, the first covering layer does not overlap with the second covering layer.

10. The waveguide structure according to claim 9, wherein an air gap is provided between the first covering layer and the cover plate layer.

11. The waveguide structure according to claim 2, wherein the refractive index of the second covering layer is lower than 1.3.

12. The waveguide structure according to claim 1, wherein the cover plate layer has a thickness not greater than 0.3 mm.

13. The waveguide structure according to claim 1, wherein a distance between surfaces of the waveguide substrate and the cover plate layer that are close to each other is not greater than 0.1 mm.

14. The waveguide structure according to claim 1, wherein the waveguide substrate has a refractive index of 1.7 to 2.8, and the grating structure has a refractive index of 1.7 to 2.8.

15. The waveguide structure according to claim 2, wherein the grating structure is located on one of the first surface and the second surface of the waveguide substrate, the cover plate layer comprises a first cover plate layer and a second cover plate layer located on both sides of the waveguide substrate, the first cover plate layer covers the grating structure, the covering layer further comprises a third covering layer located between the second cover plate layer and the waveguide substrate, the third covering layer is attached to the second cover plate layer, and the third covering layer has a refractive index lower than that of the first covering layer, and a distance between surfaces of the first cover plate layer and the waveguide substrate that are close to each other is greater than a distance between surfaces of the second cover plate layer and the waveguide substrate that are close to each other.

16. The waveguide structure according to claim 15, wherein a material of the third covering layer is the same as that of the second covering layer.

17. The waveguide structure according to claim 2, wherein the covering layer further comprises an anti-reflective film, and the anti-reflective film comprises a plurality of film layers which are arranged in a stacked manner;
the anti-reflective film is located between the first covering layer and the second covering layer, or
the anti-reflective film is located at least on one side of the first covering layer away from the waveguide substrate.

18. The waveguide structure according to claim 1, wherein a surface of at least part of the cover plate layer has at least one selected from the group consisting of a curved morphology and a plurality of microstructures.

19. A near-eye display device, comprising a waveguide structure, the waveguide structure comprising:
a waveguide substrate, comprising a first surface and a second surface opposite to each other;
a grating structure, located on at least one surface of the waveguide substrate;
a covering layer, covering the grating structure and the waveguide substrate, wherein a refractive index of the covering layer is smaller than that of the grating structure;
a cover plate layer, at least located at one side of the covering layer away from the grating structure and attached to the covering layer;
wherein the covering layer comprises a first covering layer that covers the grating structure, and the first covering layer has a refractive index greater than 1.4.

20. The near-eye display device according to claim 19, wherein the covering layer further comprises a second covering layer, the cover plate layer is attached to the second covering layer, and a refractive index of the second covering layer is lower than the refractive index of the first covering layer.
